(19) United States
(12) Patent Application Publication
(10) Pub. No.: US 2018/0289996 A1
(43) Pub. Date: Oct. 11, 2018

(54) SYSTEM AND CONTROLLING METHOD FOR EXTINGUISHING FIRE IN BATTERY OF VEHICLE

(71) Applicants: HYUNDAI MOTOR COMPANY, Seoul (KR); KIA MOTORS CORPORATION, Seoul (KR)

(72) Inventors: Dal KIM, Yongin-si (KR); Yoon Cheol JEON, Suwon-si (KR)

(21) Appl. No.: 15/717,642

(22) Filed: Sep. 27, 2017

(30) Foreign Application Priority Data
Apr. 7, 2017 (KR) 10-2017-0045343

(51) Int. Cl. A62C 3/16; A62C 3/07; A62C 37/10; A62C 37/36; A62C 37/40

(52) U.S. Cl. CPC A62C 3/16; A62C 3/07; A62C 99/0072; A62C 37/04; A62C 37/40; A62C 37/10

(57) ABSTRACT

A system and a controlling method for extinguishing a fire in a battery of a vehicle is provided for preventing the vehicle from being completely burned out and protecting consumer's physical assets by injecting cooling water of a water cooling system when a fire occurs in a battery to extinguish the fire of the battery at an early stage and by supplying an external cooling material from outside of the vehicle to extinguish the fire of the battery when the fire of the battery is not extinguished at the early stage.

### CROSS REFERENCE TO RELATED APPLICATION

The present application is based on and claims the benefit of priority to Korean Patent Application No. 10-2017-0045343, filed on Apr. 7, 2017, with the Korean Intellectual Property Office, the entire contents of which is incorporated herein for all purposes by this reference.

### TECHNICAL FIELD

The present disclosure relates to a system and a controlling method for extinguishing a fire for a battery of a vehicle, and more particularly, to a system and a controlling method for extinguishing a fire for a battery of a vehicle capable of preventing the vehicle from being completely burned out and protecting consumer's physical assets by injecting cooling water of a water cooling system when a fire occurs in a battery to extinguish the fire of the battery at an early stage and by supplying a cooling material from outside of the vehicle to extinguish the fire of the battery when the fire of the battery is not extinguished at the early stage.

### BACKGROUND

Due to worldwide high oil price and CO2 regulations, fuel efficiency improvement and an environment-friendly feature have been core issues in developing a vehicle. Advanced vehicle makers are pushing out technologies on hybrid vehicles and electric cars in order to accomplish the above-mentioned goals.

Unlike a gasoline car, an electric car is configured to include, in general, a battery, a power converter (inverter), and a motor. The battery is an energy storage device and the power converter is a device for converting electric energy of the battery to generate a required driving force, and the electric energy is used to drive the motor and the vehicle.

The electric car has the advantage of being environmentally friendly, but if a fire occurs due to an external shock, an internal short circuit or the like, the battery is completely burned out. If a battery cell catches on fire, the fire is not extinguished until the battery cell is totally burned, and since the capacity and size of the battery are considerably large, it is highly possible that the vehicle is completely burned out. Therefore, an early extinguishment of the fire in the battery is urgently required in view of fail safety.

Currently, the battery has a structure in which a fuse in the battery may be blown or a relay may be shut off when the internal short circuit occurs or an overcurrent flows. Yet, there is no such apparatus that prevents a fire in a wire, BMS or the like of a battery due to external disturbances, malfunctions or the like from being transferred to the battery cell. Since an anode active material of the battery cell supplies carbon or the like and a cathode active material of the battery supplies oxygen, once a fire occurs, the battery cell is completely burned out.

Therefore, a solution for extinguishing an early fire and extinguishing a full-scale fire is required.

The matters described as the related art have been provided only for assisting in the understanding for the background of the present disclosure and should not be considered as corresponding to the related art known to those skilled in the art.

### SUMMARY

An object of the present disclosure is to provide a system and a controlling method for extinguishing a fire for a battery of a vehicle capable of preventing the vehicle from being completely burned out and protecting consumer's physical assets by injecting cooling water of a water cooling system when a fire occurs in a battery to extinguish the fire of the battery at an early stage and being supplied with a cooling material from an outside of the vehicle to extinguish the fire of the battery when the fire of the battery is not extinguished at an early stage.

According to an exemplary embodiment of the present disclosure, a system for extinguishing a fire in a battery of a vehicle includes: a water cooling system configured to circulate cooling water for cooling a vehicle electric component and a battery; a fire extinguishing line configured to be branched from a cooling water circulating line of the water cooling system to provide the cooling water for fire extinguishment of the battery; a fire extinguishing valve configured to control a flow of the cooling water between the cooling water circulating line and the fire extinguishing line; and a controller configured to control a state of the fire extinguishing valve.

The system may further include a smoke sensor and a temperature sensor configured to sense the fire of the battery.

The system may further include a nozzle configured to be connected to a fire extinguishing line to inject the cooling water to the battery.

The controller may stop a supply of the cooling water to the cooling water circulating line for cooling the vehicle electric component and open the fire extinguishing valve when a fire occurs in the battery.

The system may further include: an external cooling material connecting device configured to be connected to an external cooling material supplying device of the vehicle; and an external connecting valve configured to control a flow of an external cooling material so that the external cooling material is supplied to the fire extinguishing line.

The external cooling material connecting device may be located in front of the vehicle.

The controller may open an external connecting valve when the external cooling material supplying device is connected to the external cooling material connecting device.

According to another exemplary embodiment of the present disclosure, a system for extinguishing a fire in a battery of a vehicle includes: a water cooling system configured to circulate cooling water for cooling a vehicle electric component and a battery; a fire extinguishing line configured to be branched from a cooling water circulating line of the water cooling system to provide the cooling water for fire extinguishment of the battery; a fire extinguishing valve configured to control a flow of the cooling water between the cooling water circulating line and the fire extinguishing line; a nozzle configured to be connected to the fire extinguishing line to inject the cooling water to the battery; an external cooling material connecting device configured to be connected to an external cooling material supplying device of the vehicle; an external connecting valve configured to control a flow of an external cooling material so that the external cooling material is supplied to the fire extinguishing line; and a controller configured to control a state of the fire extinguishing valve.

According to another exemplary embodiment of the present disclosure, a method for controlling the system for extinguishing the fire in the battery of the vehicle including: determining whether a fire occurs in the battery of the vehicle; and opening a fire extinguishing valve if it is determined that the fire occurs in the battery.

In the determining whether the fire occurs in the battery of the vehicle, when a smoke of the battery is sensed and a temperature of the battery is equal to or greater than a reference temperature, it may be determined that the fire occurs in the battery.

In the opening of the fire extinguishing valve, a supply of the cooling water to the cooling water circulating line for cooling the electric component may be stopped and the fire extinguishing valve may be opened.

The method may further include, after the opening of the fire extinguishing valve, determining whether the fire of the battery is extinguished.

When the fire of the battery is not extinguished, the external connecting valve may be opened if an external cooling material supplying device is connected to an external cooling material connecting device.

### BRIEF DESCRIPTION OF THE DRAWINGS

FIG. 1 is a configuration diagram of a system for extinguishing a fire for a battery of a vehicle according to an exemplary embodiment of the present disclosure.

FIG. 2 is a view for describing an external cooling material connecting device according to an exemplary embodiment of the present disclosure.

FIG. 3 is a view for describing an external cooling material supplying device and the external cooling material connecting device according to an exemplary embodiment of the present disclosure.

FIG. 4 is a view for describing a position where the external cooling material connecting device according to an exemplary embodiment of the present disclosure is mounted.

FIG. 5 is a flow chart of a controlling method of a system for extinguishing a fire for a battery system for a vehicle according to an exemplary embodiment of the present disclosure.

### DETAILED DESCRIPTION

Hereinafter, a system and a controlling method for extinguishing a fire for a battery of a vehicle according to various embodiments of the present disclosure will be described with reference to the accompanying drawings.

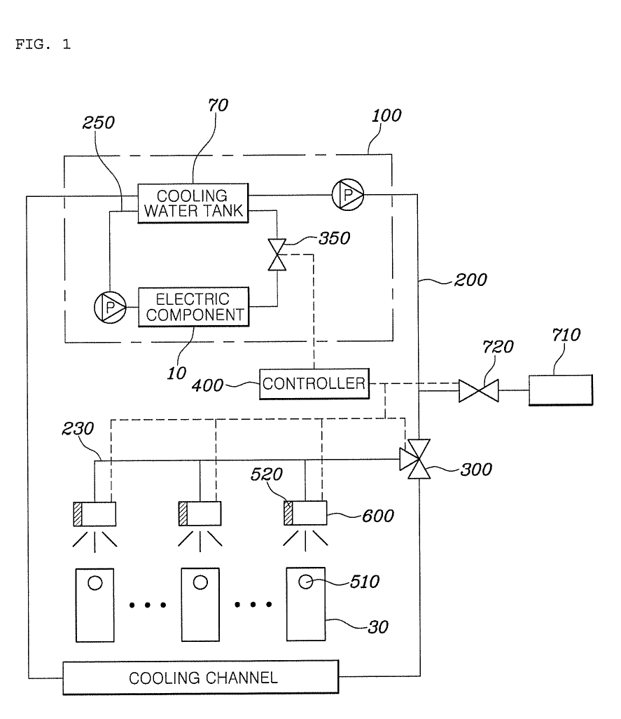

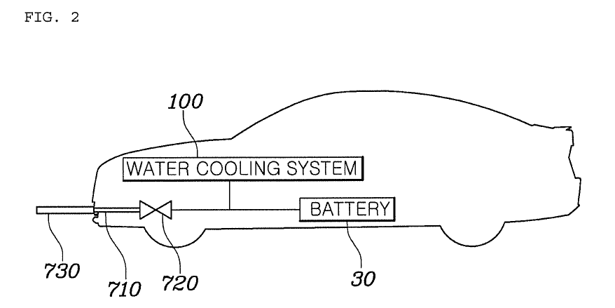

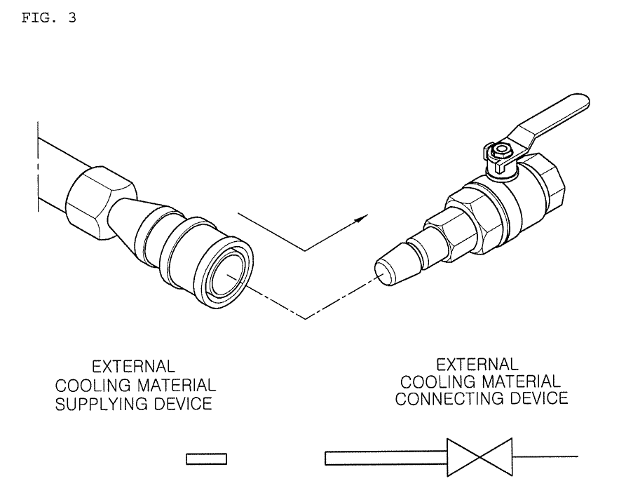

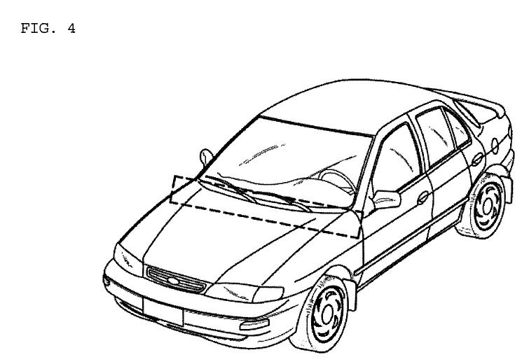

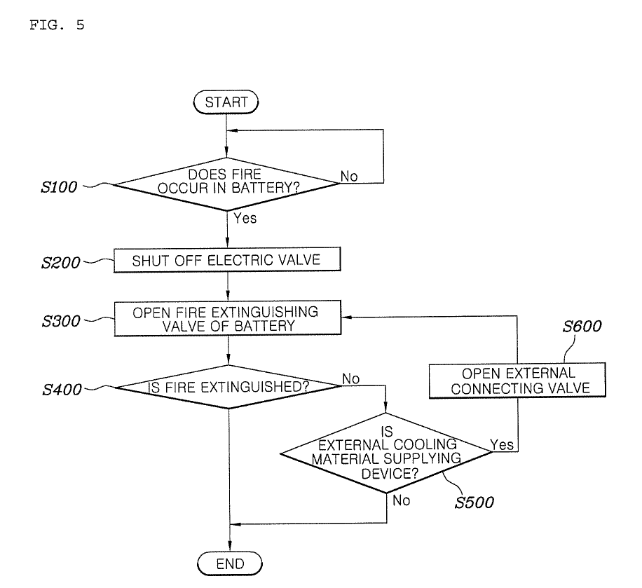

FIG. 1 is a configuration diagram of a system for extinguishing a fire for a battery of a vehicle according to an exemplary embodiment of the present disclosure, FIG. 2 is a view for describing an external cooling material connecting device according to an exemplary embodiment of the present disclosure, and FIG. 3 is a view for describing an external cooling material supplying device and the external cooling material connecting device according to an exemplary embodiment of the present disclosure. FIG. 4 is a view for describing a position where the external cooling material connecting device according to an exemplary embodiment of the present disclosure is mounted and FIG. 5 is a flow chart of a controlling method of a system for extinguishing a fire for a battery system for a vehicle according to an exemplary embodiment of the present disclosure.

Referring first to FIG. 1, a system for extinguishing a fire for a battery of a vehicle according to an exemplary embodiment of the present disclosure includes a water cooling system 100 configured to circulate cooling water for cooling a vehicle electric component 10 and a battery 30; a fire extinguishing line 230 configured to be branched from a cooling water circulating line 200 of the water cooling system 100 to provide the cooling water as fire extinguishing water for fire extinguishment of the battery 30; a fire extinguishing valve 300 configured to control a flow of the cooling water between the cooling water circulating line 200 and the fire extinguishing line 230; and a controller 400 configured to control a state of the fire extinguishing valve 300.

Here, the water cooling system 100 circulates the cooling water to the circulating line 250 for cooling the vehicle electric component 10 and the cooling water circulating line 200 for cooling the battery 30.

According to an exemplary embodiment of the present disclosure, the fire extinguishing line 230 may be provided with a nozzle 600 for injecting cooling water to the battery, and a sprinkler nozzle may be used so that cooling water or cooling gas may be unformly injected. This will lead to fail safety as the water is evenly injected.

The fire extinguishing valve 300 may control the flow of cooling water or cooling material supplied by the external cooling material supplying device that is connected to the cooling water circulating line 200 and an external cooling material connecting device 710 to be described below when a fire occurs.

According to an exemplary embodiment of the present disclosure, the system for extinguishing a fire for a battery of a vehicle may further include the external cooling material connecting device 710 configured to be connected to the external cooling material supplying device of the vehicle for efficient fire extinguishment and an external connecting valve 720 configured to control a flow of an external cooling material so that the external cooling material is supplied to the fire extinguishing line 230.

Here, as shown in FIG. 2, the external cooling material connecting device 710 may be connected to the external cooling material supplying device 730 of the vehicle. Further, as shown in FIG. 3, in order to quickly extinguish a fire in the event of a fire, according to the exemplary embodiment of the present disclosure, as the external cooling material connecting device 710, a quick connector may be used so that a firefighter or a general public opens the external connecting valve 720 and connects between cooling material hoses at one time. By the quick connector, workability may be improved and the cooling material hoses may automatically withstand watertight and a water pressure upon the connection.

According to the exemplary embodiment of the present disclosure, the external connecting valve 720 may be manually open by a worker when connecting between the external cooling material supplying device 730 to the external cooling material connecting device 710 and may be open by the controller 400 when the external cooling material supplying device 730 to be described below is connected to the external cooling material connecting device 710.

Referring to FIG. 4, according to the exemplary embodiment of the present disclosure, the external cooling material connecting device 710 may be located in front of the vehicle. The external cooling material connecting device 710 should be located at a place where a firefighter may directly access even in the event of an external collision or the like, but it is difficult to select the position of the external cooling material connecting device 710 because places where the collision may occur are quite diverse.

However, when a front collision of a normal vehicle occurs, deformation occurs up to the front tire, and the tire and a suspension prevent deformation of the position where the external cooling material connecting device 710 can be installed from the vehicle collision. Accordingly, the position where the external cooling material connecting device 710 can be installed can be seen as the safety zone (square dotted line in FIG. 4) between a body cowl and a wheel CTR of the vehicle. And the position is a space where the external cooling materials are connected to each other if a hood is open or the hood is removed when it is not opened due to a collision. A nozzle may be installed at the location. The location of the nozzle is defined as a side where the nozzle is less affected by the collision interference with other components. Therefore, the location of the foregoing cooling material connecting device 710 is an exemplary embodiment of the present disclosure and therefore is not limited thereto.

The system for extinguishing a fire for a battery of a vehicle according to the exemplary embodiment of the present disclosure may further include a smoke sensor 520 and a temperature sensor 510 to detect the fire of the battery.

Here, the temperature sensor 510 and the smoke sensor 520 may each be attached to the battery 30 and an inside of a pack, respectively, with the same area distribution.

The controller 400 may stop the supply of the cooling water to the cooling water circulating line 250 for cooling the electric component 10 and open the fire extinguishing valve 300, when a fire occurs in the battery 30.

Here, a considerable amount of smoke is generally generated before flame or a fire occurs. If the smoke sensor 520 senses smoke and the temperature sensor 510 determines that the temperature of the battery is high temperature (70° C. or more as one example of the present disclosure), the controller 400 shuts off a 2-way electric valve 350 off and delivers the cooling water supplied to the electric components 10 such as a motor and an inverter and the cooling water in the battery to a cooling water reservoir tank 70 by using the water pump. Further, the controller 400 controls the flow of the cooling water by directing a 3-way fire extinguishing valve 300 to the fire extinguishing line 230 from the cooling channel to inject the cooling water from the nozzle 600 along the fire extinguishing line 230, thereby extinguishing the fire of the battery at an early stage.

However, in the event of the full-scale fire of the battery, the fire of the battery may not be extinguished only by the water cooling system of the vehicle due to oxygen emitted from the battery itself. Therefore, a large amount of cooling water can not but be supplied from outside and sprayed to lower the temperature of the battery, thereby extinguishing the fire of the battery. The battery has a basic sealing structure, and therefore no matter how much water is sprayed from the outside, the fire may not be extinguished. Accordingly, according to the exemplary embodiment of the present disclosure, the cooling material (any liquid or gas, such as water or low-temperature nitrogen gas, capable of extinguishing a fire) may be directly injected through the external cooling material connecting device 710 that may be quickly supplied with the cooling material from the outside.

When the fire of the battery is not extinguished by the water cooling system 100 at an early stage and thus the external cooling material supplying device is connected to the external cooling material connecting device 710, the controller 400 opens the external connecting valve 720 to inject the cooling material through the fire extinguishing line 230. As a result, it is possible to shorten the extinguishing time due to the active fire extinguishment using the external cooling material connecting device 710 and protect the environment by preventing the vehicle from being completely burned out.

Referring to FIG. 5, a method for controlling a system for extinguishing a fire for a battery of a vehicle according to an exemplary embodiment of the present disclosure includes determining whether a fire occurs in the battery of the vehicle (S100) and opening the fire extinguishing valve if it is determined that the fire occurs in the battery (S300).

In the determining whether a fire occurs in the battery of the vehicle (S100), when the smoke of the battery is sensed and the temperature is equal to or grater than a reference temperature, it may be determined that a fire occurs in the battery.

Here, the smoke may be detected by the smoke sensor, and the reference temperature may be 70° C. as described above as in the example of the present disclosure.

In the opening of the fire extinguishing valve (S300), the supply of the cooling water to the cooling water circulating line for cooling the electric components may stop and the fire extinguishing valve may be open (S200, S300).

Here, if it is determined that the fire occurs in the battery, the 2-way electric valve 350 is shut off to stop the supply of the cooling water to the cooling water circulating line for cooling the electric component, and the cooling water which is supplied to the electric components 10 such as the motor and the inverter and the cooling water in the battery are delivered to the cooling water reservoir tank 70 by the water pump. Further, the controller 400 controls the flow of the cooling water by directing a 3-way fire extinguishing valve 300 to the fire extinguishing line 230 from the cooling channel to inject the cooling water from the nozzle 600 along the fire extinguishing line 230, thereby extinguishing the fire of the battery at an early stage.

The method may further include determining whether the fire of the battery is extinguished (S400) after the opening of the fire extinguishing valve (S300).

Here, in the event of the full-scale fire of the battery, the fire of the battery may not be extinguished only by the water cooling system of the vehicle due to oxygen emitted from the battery itself. Therefore, a large amount of cooling water may be supplied from outside and sprayed to lower the temperature of the battery, thereby extinguishing the fire of the battery. The battery has a basic sealing structure, and therefore no matter how much water is sprayed from the outside, the fire may not be extinguished.

Therefore, when the fire of the battery is not extinguished, according to the exemplary embodiment of the present disclosure, the external connecting valve may be open if the external cooling material supplying device is connected to the external cooling material connecting device (S500 and S600). Accordingly, the cooling material (any liquid or gas, such as water or low-temperature nitrogen gas, capable of extinguishing a fire) may be directly injected through the external cooling material connecting device 710 that may be quickly supplied with the cooling material from the outside, thereby quickly extinguishing the fire.

The system and the controlling method for extinguishing a fire for a battery of a vehicle according to the exemplary embodiment of the present disclosure, the supply of the cooling material to the fire extinguishing line through the external cooling material connecting device may be performed when the fire of the battery is not extinguished at an early stage by the water cooling system of the vehicle and the supply of the external cooling material by the external cooling material supplying device and the supply of the cooling water by the water cooling system of the vehicle itself may be simultaneously performed according to the selection in the state where the external cooling material supplying device is provided when a fire occurs in the battery. As a result, a fire can be more quickly and efficiently extinguished at an early stage than the fire extinguishment by the water cooling system of the vehicle itself.

As described above, the system and the controlling method for extinguishing a fire for a battery of a vehicle according to various exemplary embodiments of the present disclosure can prevent the vehicle from being completely burned out and can normally operate the vehicle by replacing only the battery, thereby protecting the consumer's physical assets.

In addition, it is possible to improve the consumer stability and reliability by securing the fail safety for the fire of the battery.

In addition, it is possible to protect the environment and shorten the extinguishment time by the active fire extinguishment using the external connection structure of the vehicle.

Although the present disclosure has been shown and described with respect to specific exemplary embodiments, it will be obvious to those skilled in the art that the present invention may be variously modified and altered without departing from the spirit and scope of the present invention as defined by the following claims.

What is claimed is:

1. A system for extinguishing a fire in a battery of a vehicle, comprising:
a water cooling system configured to circulate cooling water for cooling a vehicle electric component and the battery;
a fire extinguishing line configured to be branched from a cooling water circulating line of the water cooling system to provide the cooling water for fire extinguishment of the battery;
a fire extinguishing valve configured to control a flow of the cooling water between the cooling water circulating line and the fire extinguishing line; and
a controller configured to control a state of the fire extinguishing valve.

2. The system of claim 1, further comprising:
a smoke sensor and a temperature sensor configured to sense the fire of the battery.

3. The system of claim 1, further comprising:
a nozzle configured to be connected to the fire extinguishing line to inject the cooling water to the battery.

4. The system of claim 1, wherein, when a fire occurs in the battery, the controller stops a supply of the cooling water to the cooling water circulating line for cooling the vehicle electric component and opens the fire extinguishing valve.

5. The system of claim 1, further comprising:
an external cooling material connecting device configured to be connected to an external cooling material supplying device of the vehicle; and
an external connecting valve configured to control a flow of an external cooling material so that the external cooling material is supplied to the fire extinguishing line.

6. The system of claim 5, wherein the external cooling material connecting device is located in front of the vehicle.

7. The system of claim 5, wherein the controller opens the external connecting valve when the external cooling material supplying device is connected to the external cooling material connecting device.

8. A system for extinguishing a fire in a battery of a vehicle, comprising:
a water cooling system configured to circulate cooling water for cooling a vehicle electric component and the battery;
a fire extinguishing line configured to be branched to from cooling water circulating line of the water cooling system to provide the cooling water for fire extinguishment of the battery;
a fire extinguishing valve configured to control a flow of the cooling water between the cooling water circulating line and the fire extinguishing line;
a nozzle configured to be connected to the fire extinguishing line to inject the cooling water to the battery;
an external cooling material connecting device configured to be connected to an external cooling material supplying device of the vehicle;
an external connecting valve configured to control a flow of an external cooling material so that the external cooling material is supplied to the fire extinguishing line; and
a controller configured to control a state of the fire extinguishing valve.

9. A method for controlling the system for extinguishing the fire in the battery of the vehicle of claim 8, comprising:
determining, by the controller, whether a fire occurs in the battery of the vehicle; and
opening, by the controller, the fire extinguishing valve if it is determined that the fire occurs in the battery.

10. The method of claim 9, wherein in the determining whether the fire occurs in the battery of the vehicle, when a smoke of the battery is sensed and a temperature of the battery is equal to or greater than a reference temperature, it is determined that the fire occurs in the battery.

11. The method of claim 9, wherein in the opening of the fire extinguishing valve, a supply of the cooling water to the cooling water circulating line for cooling the electric component is stopped and the fire extinguishing valve is opened.

12. The method of claim 9, further comprising:
after the opening of the fire extinguishing valve, determining, by the controller, whether the fire of the battery is extinguished.

13. The method of claim 12, wherein when the fire of the battery is not extinguished, the external connecting valve is opened if the external cooling material supplying device is connected to the external cooling material connecting device.
